(19) United States
(12) Patent Application Publication
(10) Pub. No.: US 2024/0383214 A1
(43) Pub. Date: Nov. 21, 2024

(54) FORMATION OF THERMOPLASTIC COMPOSITE REBAR

(71) Applicants: Alexandros TSAMIS, Brooklyn, NY (US); Daniel F. WALCZYK, Troy, NY (US); Daniel M. COHEN, Brooklyn, NY (US); RENSSELAER POLYTECHNIC INSTITUTE, Troy, NY (US)

(72) Inventors: Alexandros Tsamis, Brooklyn, NY (US); Daniel F. Walczyk, Troy, NY (US); Daniel M. Cohen, Brooklyn, NY (US)

(73) Assignee: RENSSELAER POLYTECHNIC INSTITUTE, Troy, NY (US)

(21) Appl. No.: 18/691,919

(22) PCT Filed: Sep. 14, 2022
(86) PCT No.: PCT/US2022/043404

§ 371 Date: Mar. 14, 2024

Related U.S. Application Data
(60) Provisional application No. 63/243,869, filed on Sep. 14, 2021.

(51) Int. Cl. B29C 70/52; B29C 53/02; B29C 53/32; B29C 70/54; B29K 105/10; B29K 301/12; B29L 31/06

(52) U.S. Cl. CPC B29C 70/527; B29C 53/02; B29C 53/32; B29C 70/528; B29C 70/545; B29C 2793/009; B29K 2105/10; B29K 2301/12; B29L 2031/06

(57) ABSTRACT

A system for producing rebar includes a pultruding machine configured to receive a flexible rebar preform. The flexible rebar preform includes at least one reinforcement filament, and at least one thermoplastic filament. The at least one reinforcement filament, and the at least one thermoplastic filament are arranged in a selected distribution across a cross-section of the preform. The pultruding machine includes a pulling apparatus, a rebar cutting apparatus, and a bending apparatus. The pultruding machine is configured to heat the flexible rebar preform to a first temperature. The first temperature is greater than or equal to a melt temperature of the thermoplastic filaments. The pulling apparatus is configured to pull the flexible rebar preform through a pultrusion die to form the rebar. The rebar cutting apparatus is configured to cut the rebar at a prespecified length. The bending apparatus is configured to bend the cut rebar to a prespecified bend geometry.

### CROSS REFERENCE TO RELATED APPLICATION(S)

This application claims the benefit of U.S. Provisional Application No. 63/243,869, filed Sep. 14, 2021, which is incorporated by reference as if disclosed herein in its entirety.

### FIELD

The present disclosure relates to rebar, in particular to, formation of thermoplastic composite rebar.

### BACKGROUND

Concrete is relatively strong under compression, but has relatively weak tensile strength Reinforcing rod, also known as “reinforcing bar” or “rebar”, is used as a tension device in reinforced concrete and reinforced masonry structures to strengthen the concrete under tension. Rebar is commonly made of steel and is, thus, susceptible to corrosion. Steel reinforcing bars may be coated in an epoxy resin or a sacrificial layer of zinc via galvanization to mitigate corrosion. The epoxy can actually worsen the corrosion effects while galvanizing provides relatively little protection against chloride attack.

### SUMMARY

In some embodiments, there is provided a flexible rebar preform. The flexible rebar preform includes at least one reinforcement filament, and at least one thermoplastic filament. The at least one reinforcement filament and the at least one thermoplastic filament are arranged in a selected distribution across a cross-section of the preform.

In some embodiments, the flexible rebar preform includes a plurality of thermoplastic filaments. A concentration of the plurality of thermoplastic filaments across the cross-section of the preform has a gradient configured to provide at least one of a selected mechanical property and/or a selected processing characteristic.

In some embodiments of the flexible rebar preform, a ratio of reinforcement filament volume to preform volume is related to one or more of an interfacial shear strength between a reinforcement filament material and a thermoplastic filament material, an associated rebar tensile modulus, an associated rebar tensile strength, an associated rebar bending modulus, and/or an associated rebar bending strength.

In some embodiments, the flexible rebar preform includes at least one of a sleeve or a braid configured to contain the at least one reinforcement filament and the at least one thermoplastic filament

In some embodiments of the flexible rebar preform, each reinforcement filament includes a natural fiber.

In some embodiments of the flexible rebar preform, each reinforcement filament includes a material selected from the group comprising hemp, flax, glass, jute, kenaf, ramie, sisal, basalt, carbon, aramid, and/or a combination thereof.

In some embodiments of the flexible rebar preform, each thermoplastic filament includes a material selected from the group comprising PET (poly(ethylene terephthalate)), polyamide polymer, HDPE (high-density polyethylene), polyethylene, PMMA (poly methyl methacrylate), polyester, PLA (polylactic acid), POM (poly oxy methylene), polypropylene, polyurethane, PVDF (polyvinylidene fluoride) and/or a combination thereof.

In some embodiments, there is provided a method of producing rebar. The method includes receiving, by a pultruding machine, a flexible rebar preform. The flexible rebar preform includes at least one reinforcement filament, and at least one thermoplastic filament. The at least one reinforcement filament, and the at least one thermoplastic filament are arranged in a selected distribution across a cross-section of the preform. The method further includes heating, by the pultruding machine, the flexible rebar preform to a first temperature. The first temperature is greater than or equal to a melt temperature of the thermoplastic filament. The method further includes pulling, by a pulling apparatus, the flexible rebar preform through a pultrusion die to form the rebar; cutting, by a rebar cutting apparatus, the rebar at a prespecified length; and bending, by a bending apparatus, the cut rebar to a prespecified bend geometry.

In some embodiments of the method, the flexible rebar preform is received coiled around a spool, or coiled in a cassette.

In some embodiments, the method further includes preheating, by a preheating apparatus, the flexible rebar preform to a second temperature. The second temperature is less than a melt temperature of the thermoplastic filament.

In some embodiments of the method, the heating to the first temperature occurs in the pultrusion die.

In some embodiments of the method, the pulling apparatus includes a plurality of drive rollers, and the method further includes texturing, by the plurality of drive rollers, an outer surface of the rebar.

In some embodiments of the method, the pultruding machine is configured to be portable and to produce the rebar on a job site.

In some embodiments of the method, the flexible rebar preform includes a plurality of thermoplastic filaments. A concentration of the plurality of thermoplastic filaments across the cross-section of the preform has a gradient configured to provide at least one of a selected mechanical property and/or a selected processing characteristic.

In some embodiments of the method, a ratio of reinforcement filament volume to preform volume is related to one or more of an interfacial shear strength between a reinforcement filament material and a thermoplastic filament material, an associated rebar tensile modulus, an associated rebar tensile strength, an associated rebar bending modulus and/or an associated rebar bending strength.

In some embodiments of the method, the flexible rebar preform includes at least one of a sleeve or a braid configured to contain the at least one reinforcement filament and the at least one thermoplastic filament.

In some embodiments, there is provided a system for producing rebar. The system includes a pultruding machine configured to receive a flexible rebar preform. The flexible rebar preform includes at least one reinforcement filament, and at least one thermoplastic filament. The at least one reinforcement filament, and the at least one thermoplastic filament are arranged in a selected distribution across a cross-section of the preform. The pultruding machine includes a pulling apparatus, a rebar cutting apparatus, and a bending apparatus. The pultruding machine is configured to heat the flexible rebar preform to a first temperature. The first temperature is greater than or equal to a melt temperature of the thermoplastic filaments. The pulling apparatus is configured to pull the flexible rebar preform through a pultrusion die to form the rebar. The rebar cutting apparatus is configured to cut the rebar at a prespecified length. The bending apparatus is configured to bend the cut rebar to a prespecified bend geometry.

In some embodiments of the system, each reinforcement filament includes a material selected from the group comprising hemp, flax, glass, jute, kenaf, ramie, sisal, basalt, carbon, aramid and/or a combination thereof.

In some embodiments of the system, each thermoplastic filament includes a material selected from the group comprising PET (poly(ethylene terephthalate)), polyamide polymer, HDPE (high-density polyethylene), polyethylene, PMMA (poly methyl methacrylate), polyester, PLA (polylactic acid), POM (poly oxy methylene), polypropylene, polyurethane, PVDF (polyvinylidene fluoride) and/or a combination thereof.

In some embodiments, the system further includes a preheating apparatus configured to preheat the flexible rebar preform to a second temperature. The second temperature is less than a melt temperature of the thermoplastic filament.

### BRIEF DESCRIPTION OF DRAWINGS

The drawings show embodiments of the disclosed subject matter for the purpose of illustrating features and advantages of the disclosed subject matter. However, it should be understood that the present application is not limited to the precise arrangements and instrumentalities shown in the drawings, wherein:

FIG. 1 illustrates a functional block diagram of a system for producing rebar, according to several embodiments of the present disclosure;

FIGS. 2A through 2F illustrate six flexible rebar preform configurations, according to several embodiments of the present disclosure;

FIGS. 3A through 3F are cross-section views illustrating a variety of reinforcement filament and thermoplastic filament distributions, according to several embodiments of the present disclosure;

FIG. 4 is a sketch illustrating one example roller and bending configuration, according to one embodiment of the present disclosure;

FIG. 5 is a sketch illustrating one example bending mechanism, according to one embodiment of the present disclosure; and

FIG. 6 is a sketch illustrating one example system for producing rebar, according to one embodiment of the present disclosure.

Although the following Detailed Description will proceed with reference being made to illustrative embodiments, many alternatives, modifications, and variations thereof will be apparent to those skilled in the art.

### DETAILED DESCRIPTION

Thermoplastic fiber composite (e.g., glass fiber reinforced polymer (GFRP)) rebar is a noncorrosive alternative to steel rebar. While steel rebar can typically be formed, e.g., bent, on-site, thermoplastic fiber composite rebar generally cannot be bent on-site. Such rebar is typically shaped during manufacturing at a manufacturing facility and then transported to a job site.

Generally, this disclosure relates to formation of thermoplastic composite rebar that can be formed in a factory setting or can be formed on-site. The thermoplastic composite rebar, according to the present disclosure, may be formed from a flexible rebar preform that includes at least one reinforcement filament and at least one thermoplastic filament. In some embodiments, the at least one reinforcement filament and the at least one thermoplastic filament may be contained within a braided or continuous thermoplastic sleeve. In some embodiments, the at least one reinforcement filament and the at least one thermoplastic filament may not be contained within a braided or continuous thermoplastic sleeve. In one nonlimiting example, the reinforcement filament may include a natural fiber. However, this disclosure is not limited in this regard. The thermoplastic filament is configured to form a thermoplastic matrix in the thermoplastic composite rebar. The thermoplastic composite rebar is configured to be non-corrosive thus significantly lengthening the service life of reinforced concrete. Some natural fibers (e.g., hemp, flax) have higher tensile strength compared to steel reinforcing, and when combined with a thermoplastic matrix, are configured to have a lower embodied energy and carbon footprint than steel over a service life of the rebar.

A method, apparatus and/or system may be configured to produce rebar, by a pultruding machine, in a manufacturing facility or on-site at the job site. A flexible rebar preform may include at least one reinforcement filament, and at least one thermoplastic filament. A number and type of reinforcement filaments, a number and type of thermoplastic filaments, and/or a ratio of reinforcement filament volume to preform volume may be selected based, at least in part, on one or more of an interfacial shear strength between a reinforcement filament material and a thermoplastic filament material, an associated rebar tensile modulus, an associated rebar tensile strength, an associated rebar bending modulus and/or an associated rebar bending strength. As used herein, “type” corresponds to a selected material or materials included in each reinforcement filament and/or each thermoplastic filament. For example, a thermoplastic filament may be homogenous or heterogeneous. Whether the thermoplastic filament is homogenous or heterogeneous may be related to a target mechanical property. In some embodiments, a thermoplastic filament concentration gradient across a cross section of the flexible rebar preform may be configured to provide a tailorable mechanical property and/or processing characteristic.

The flexible rebar preform that includes at least one reinforcement filament, and at least one thermoplastic filament may be provided to the pultruding machine. The flexible rebar preform may then be formed into an associated rebar that has a selected mechanical feature. The mechanical feature may include, but is not limited, to a rebar length, a bend geometry (e.g., number of bends, angle of each bend, orientation of each bend, etc.), a surface texture, and/or a combination thereof.

In an embodiment, there is provided a system for producing rebar. The system includes a pultruding machine configured to receive a flexible rebar preform. The flexible rebar preform includes at least one reinforcement filament, and at least one thermoplastic filament. The at least one reinforcement filament, and the at least one thermoplastic filament are arranged in a selected distribution across a cross-section of the preform. The pultruding machine includes a pulling apparatus, a rebar cutting apparatus, and a bending apparatus. The pultruding machine is configured to heat the flexible rebar preform to a first temperature. The first temperature is greater than or equal to a melt temperature of the thermoplastic filaments. The pulling apparatus is configured to pull the flexible rebar preform through a pultrusion die to form the rebar. The rebar cutting apparatus is configured to cut the rebar at a prespecified length. The bending apparatus is configured to bend the cut rebar to a prespecified bend geometry.

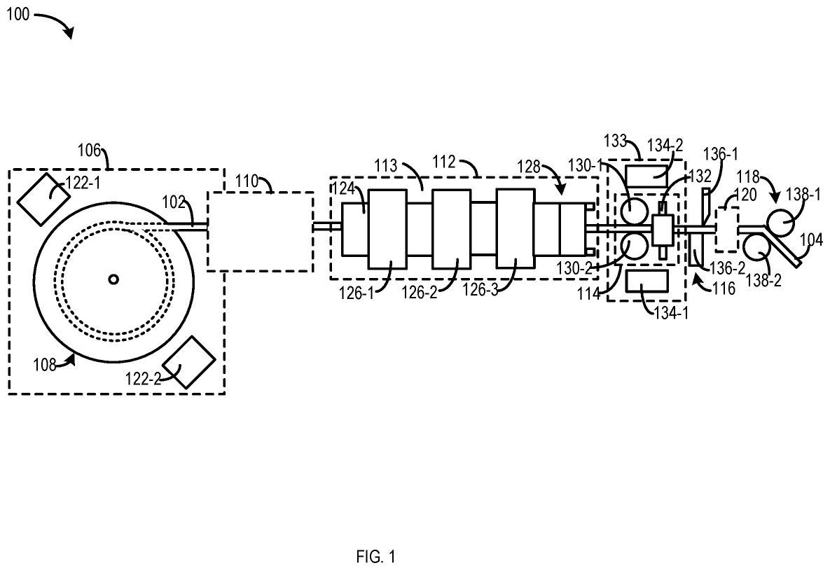

FIG. 1 illustrates a functional block diagram of a system 100 for producing composite thermoplastic rebar, according to several embodiments of the present disclosure. System 100 is configured to receive a flexible rebar preform (“preform”) 102 as input, and to produce a rebar 104 as output. “Preform” and “flexible rebar preform” are used interchangeably herein. System 100 includes a plurality of processing stages configured to receive the flexible rebar preform 102 and to produce the rebar 104. The rebar 104 is configured to have a predetermined length and geometry and may have a prespecified mechanical property. The prespecified mechanical property and/or processing characteristic may be related to a feature of the flexible rebar preform 102.

The preform 102 includes at least one reinforcement filament and at least one thermoplastic filament, as described herein. The at least one reinforcement filament and the at least one thermoplastic filament may be commingled, as described herein. As used herein, “commingled” and “comingled” are used interchangeably. The at least one reinforcement filament and the at least one thermoplastic filament may be arranged in a selected distribution across a cross-section of the preform 102, as will be described in more detail below.

Each reinforcement filament may include one or more material(s). The reinforcement filament material(s) may include, but are not limited to, hemp, flax, glass, jute, kenaf, ramie, sisal, basalt, carbon, aramid and/or a combination thereof. As used herein, “type” with respect to reinforcement filament corresponds to the material (or materials) included in the reinforcement filament. In one nonlimiting example, a selected reinforcement filament may include a natural fiber.

Each thermoplastic filament may include one or more material(s). The thermoplastic filament material(s) may include, but are not limited to, PET (poly(ethylene terephthalate)), polyamide polymer, HDPE (high-density polyethylene), polyethylene, PMMA (poly methyl methacrylate), polyester, PLA (polylactic acid), POM (poly oxy methylene), polypropylene, polyurethane, PVDF (polyvinylidene fluoride) and/or a combination thereof. As used herein, “type” with respect to thermoplastic filament corresponds to the material (or materials) included in the thermoplastic filament.

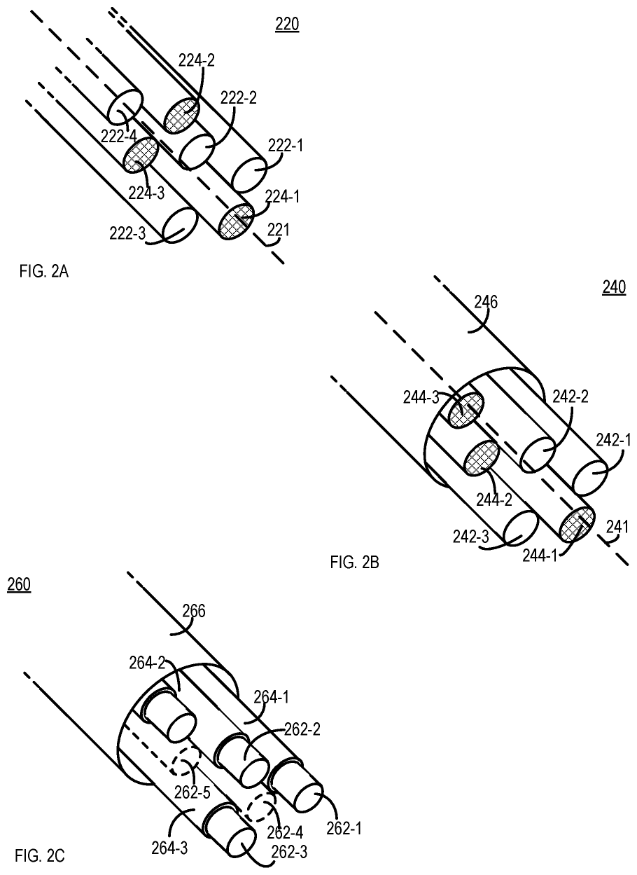

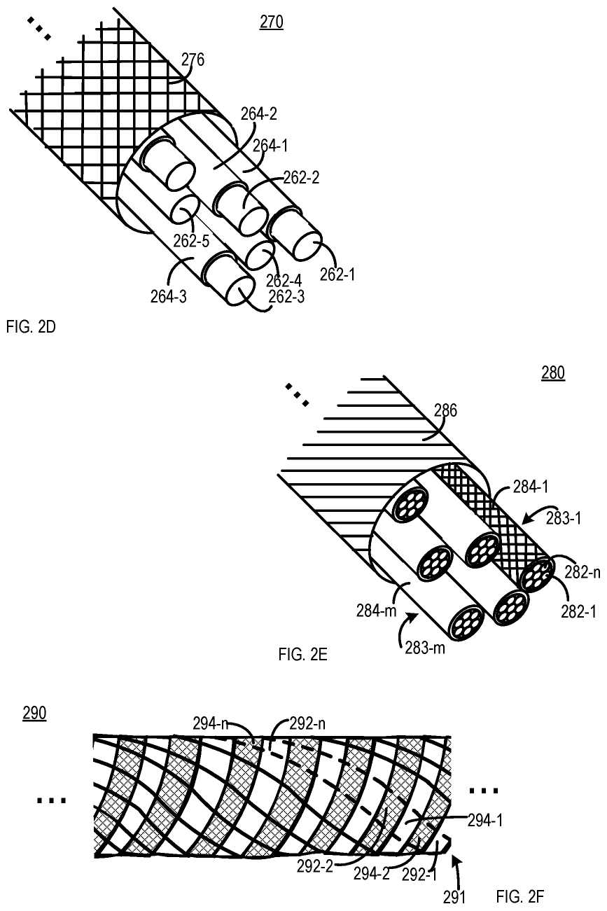

FIGS. 2A through 2F illustrate six flexible rebar preform configurations 220, 240, 260, 270, 280, 290, according to several embodiments of the present disclosure. It should be noted that a respective number of reinforcement filaments and a respective number of thermoplastic filaments shown in configurations 220, 240, 260, 270, 280, 290 are meant to illustrate example configurations and are not meant to be limited to the particular numbers shown. More or fewer reinforcement filaments and more or fewer thermoplastic filaments may be implemented, within the scope of the present disclosure.

Turning first to FIG. 2A, a first flexible rebar preform configuration 220 corresponds to a parallel configuration. The first flexible rebar preform configuration 220 includes a plurality of reinforcement filaments 222-1, 222-2, 222-3 and a plurality of thermoplastic filaments 224-1, 224-2, 224-3, 224-4, arranged substantially in parallel along a long axis 221.

Turning now to FIG. 2B, a second flexible rebar preform configuration 240 is configured to illustrate a parallel configuration with a sleeve (or jacket). The second flexible rebar preform configuration 240 includes a plurality of reinforcement filaments 242-1, 242-2, 242-3 and a plurality of thermoplastic filaments 244-1, 244-2, 244-3, arranged substantially in parallel along a long axis 241. The second flexible rebar preform configuration 240 further includes a sleeve 246, configured to contain the plurality of reinforcement filaments 242-1, 242-2, 242-3 and the plurality of thermoplastic filaments 244-1, 244-2, 244-3. In one nonlimiting example, the sleeve 246 may be formed of a thermoplastic material similar to or the same as the thermoplastic filaments. In another example, the sleeve 246 may be formed of a thermoplastic material different from the thermoplastic material(s) used for the thermoplastic filaments.

Turning now to FIG. 2C, a third flexible rebar preform configuration 260 is configured to illustrate a parallel configuration with a preform sleeve (or jacket) and tubular thermoplastic filaments. The third flexible rebar preform configuration 260 includes a plurality of reinforcement filaments 262-1, 262-2, 262-3, 262-4, 262-5, and a plurality of tubular thermoplastic filaments 264-1, 264-2, 264-3. In this third configuration 260, each thermoplastic filament defines an opening configured to receive a respective reinforcement filament. For example, a first thermoplastic filament 264-1 is configured to receive a first reinforcement filament 262-1, a second thermoplastic filament 264-2 is configured to receive a second reinforcement filament 262-2, and a third thermoplastic filament 264-3 is configured to receive a third reinforcement filament 262-3. Thus, each thermoplastic filament may correspond to a filament sleeve or filament jacket for a corresponding reinforcement filament. At least some reinforcement filaments, e.g., reinforcement filaments 262-4, 264-5, may not have a corresponding thermoplastic filament sleeve. However, this disclosure is not limited in this regard. In some embodiments, each reinforcement filament may have a corresponding tubular thermoplastic filament as a filament sleeve. In other words, reinforcement filaments 262-4, 262-5 may have corresponding thermoplastic sleeves or may not be present.

The third flexible rebar preform configuration 260 further includes a sleeve 266, configured to contain the plurality of reinforcement filaments 262-1, 262-2, 262-3, 262-4, 262-5 and the plurality of tubular thermoplastic filaments 264-1, 264-2, 264-3. In one nonlimiting example, the sleeve 266 may be formed of a thermoplastic material similar to or the same as the thermoplastic filaments. In another example, the sleeve 266 may be formed of a thermoplastic material different from the thermoplastic material(s) used for the thermoplastic filaments.

Turning now to FIG. 2D, a fourth flexible rebar preform configuration 270 is configured to illustrate a parallel configuration with a braided preform sleeve (or jacket) 276 and tubular thermoplastic filaments. The braided sleeve 276 is configured to contain the plurality of reinforcement filaments 262-1, 262-2, 262-3, 262-4, 262-5, and the plurality of tubular thermoplastic filaments 264-1, 264-2, 264-3. The braided sleeve 276 may be formed by braiding a plurality of filaments. The sleeve 276 may be formed of a reinforcement material, as described herein, and/or a thermoplastic material, as described herein. In one nonlimiting example, the sleeve 276 may be formed of material(s) similar to or the same as the filaments. In another example, the sleeve 276 may be formed of material(s) different from the material(s) used for the filaments.

Turning now to FIG. 2E, a fifth flexible rebar preform configuration 280 is configured to illustrate a parallel configuration with a twisted preform sleeve (or jacket) 286 and a plurality of filament subassemblies 283-1, . . . , 283-m. Each filament subassembly, e.g., filament subassembly 283-1, includes a respective plurality of reinforcement filaments 282-1, . . . , 282-n, and a tubular thermoplastic filament 284-1. Thus, the flexible rebar preform configuration 280 includes a plurality of tubular thermoplastic filaments 284-1, . . . , 284-m. Each tubular thermoplastic filament, e.g., tubular thermoplastic filament 284-1, may have a selected tubular structure. The thermoplastic filament tubular structure may include, but is not limited to, a continuous tube, a braided tube or a twisted tube.

The twisted sleeve 286 may be formed by twisting a plurality of filaments. The sleeve 286 may be formed of a reinforcement material, as described herein, and/or a thermoplastic material, as described herein. In one nonlimiting example, the sleeve 286 may be formed of thermoplastic material(s) similar to or the same as the thermoplastic filaments. In another example, the sleeve 286 may be formed of thermoplastic material(s) different from the material(s) used for the thermoplastic filaments.

FIG. 2F is a side view of a sixth flexible rebar preform configuration 290, configured to illustrate a twisted filament configuration. The sixth flexible rebar preform configuration 290 includes a plurality of twisted composite filaments that are twisted together to form the flexible rebar preform. The sixth flexible rebar preform configuration 290 includes a plurality of twisted composite filaments, e.g., twisted composite filament 291 bounded by dotted lines. Twisted composite filament 291 includes a plurality of reinforcement filament portions 292-1, 292-2, . . . , 292-n and a plurality of thermoplastic filament portions 294-1, 294-2, . . . , 294-n. It may be appreciated that the plurality of reinforcement filament portions correspond to a selected reinforcement filament and 292-1, 292-2, . . . , 292-n and the plurality of thermoplastic filament portions 294-1, 294-2, . . . , 294-n correspond to a selected thermoplastic filament. Only the portions are visible in the side view 290. In one nonlimiting example, the sixth flexible rebar preform configuration 290 may be formed by first twisting respective pairs of filaments that each include a reinforcement filament and a thermoplastic filament to form each twisted composite filament (e.g., twisted composite filament 291), and then twisting together a plurality of twisted composite filaments to form the flexible rebar preform 290.

Thus, a flexible rebar preform, according to the present disclosure, may include at least one reinforcement filament and at least one thermoplastic filament. The filaments may be arranged in a variety of configurations, and may include a preform sleeve and/or one or more thermoplastic filament sleeves.

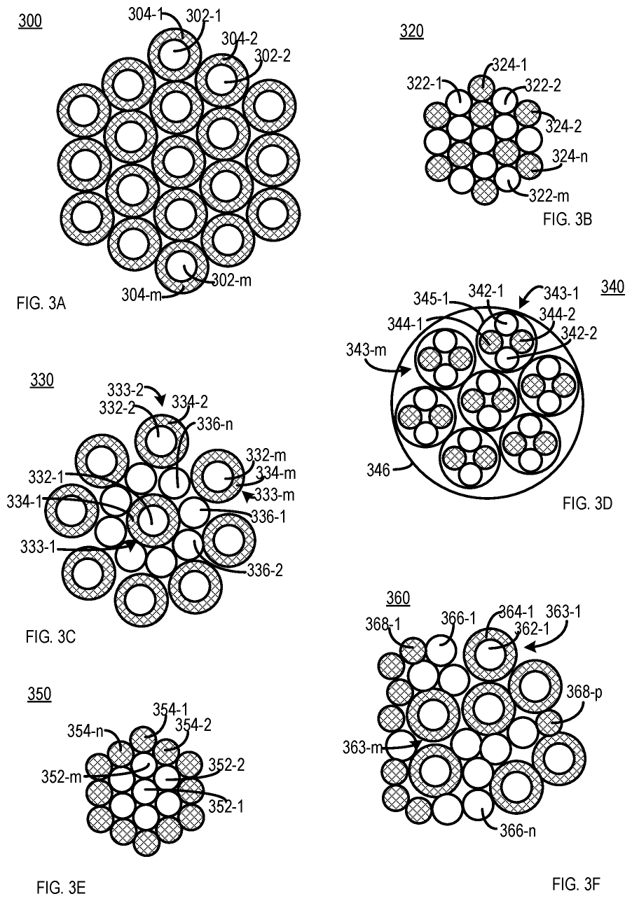

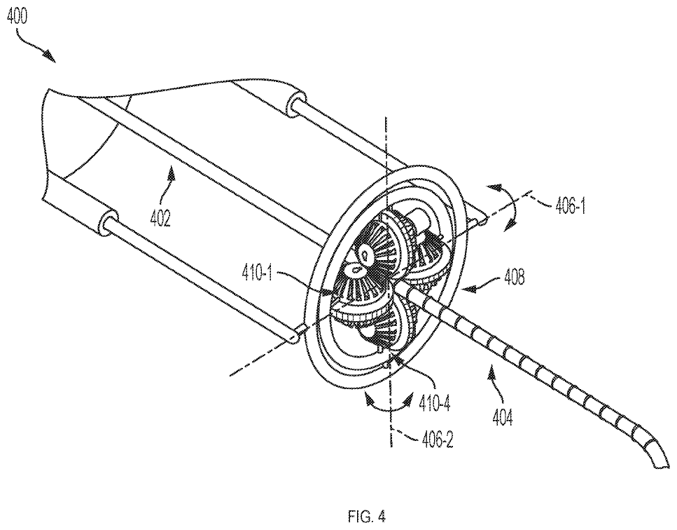

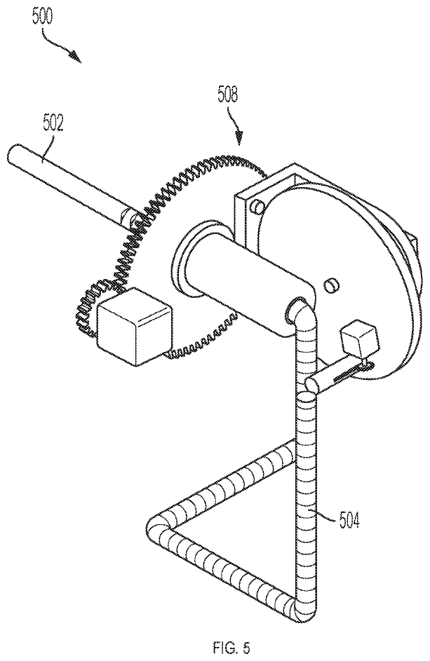

FIGS. 3A through 3F are cross-section views illustrating a variety of reinforcement filament and thermoplastic filament distributions 300, 320, 330, 340, 350, 360, according to several embodiments of the present disclosure. It should be noted that the filament distributions (i.e., flexible rebar preform distribution), as well as a respective number of reinforcement filaments and a respective number of thermoplastic filaments shown in configurations 300, 320, 330, 340, 350, 360 are meant to illustrate example configurations and are not meant to be limited to the particular distributions and particular numbers of filaments (both reinforcement and thermoplastic) shown. More or fewer reinforcement filaments, more or fewer thermoplastic filaments and different distributions may be implemented, within the scope of the present disclosure.

Turning first to FIG. 3A, a first reinforcement filament and thermoplastic filament distribution 300 is configured to illustrate a uniform distribution with a same number of tubular thermoplastic filaments as reinforcement filaments. The first flexible rebar preform configuration 300 includes a plurality of reinforcement filaments 302-1, 302-2, . . . , 302-m, and a plurality of tubular thermoplastic filaments 304-1, 304-2, . . . , 304-m. In this first distribution 300, each thermoplastic filament defines an opening configured to receive a respective reinforcement filament. For example, a first thermoplastic filament 304-1 is configured to receive a first reinforcement filament 302-1, a second thermoplastic filament 304-2 is configured to receive a second reinforcement filament 302-2, and an m^{th} thermoplastic filament 304-m is configured to receive an m^{th} reinforcement filament 302-m. Thus, each thermoplastic filament may correspond to a filament sleeve or filament jacket for a corresponding reinforcement filament.

Turning now to FIG. 3B, a second reinforcement filament and thermoplastic filament distribution 320 is configured to illustrate a nonuniform distribution with unequal numbers of tubular thermoplastic filaments and reinforcement filaments. The second flexible rebar preform distribution 320 includes a plurality of reinforcement filaments 322-1, 322-2, . . . , 322-m, and a plurality of tubular thermoplastic filaments 324-1, 324-2, . . . , 324-n. In this second distribution 320, a number, m, reinforcement filaments is not equal to a number, n, thermoplastic filaments. Additionally or alternatively, in this second distribution 320, the reinforcement filaments and the thermoplastic filaments are not uniformly distributed across the cross-section 320 of the flexible rebar preform.

Turning now to FIG. 3C, a third reinforcement filament and thermoplastic filament distribution 330 is configured to illustrate a combination distribution with both tubular thermoplastic filament and reinforcement filament pairs and reinforcement filaments without corresponding filament sleeves. The third flexible rebar preform configuration 330 includes a plurality of reinforcement filaments 332-1, 332-2, . . . , 332-m paired with a plurality of tubular thermoplastic filaments 334-1, 334-2, . . . , 334-m, and a plurality of unpaired reinforcement filaments 336-1, 336-2, . . . , 336-n. Thus, a first filament pair 333-1 includes a first reinforcement filament 332-1 and a corresponding first thermoplastic filament sleeve 334-1, and an m^{th} filament pair 333-m includes an m^{th} reinforcement filament 332-m and a corresponding m^{th} thermoplastic filament sleeve 334-m. The first filament pair 333-1 may generally be centered in this third distribution 330, and is generally surrounded by a ring of unpaired reinforcement filaments 336-1, 336-2, . . . , 336-n. The ring of unpaired reinforcement filaments 336-1, 336-2, . . . , 336-n is generally encircled by an outer ring of filament pairs 333-2, . . . , 333-m. Thus, the third distribution 330 includes a combination of tubular thermoplastic filament and reinforcement filament pairs, e.g., pair 333-1, and reinforcement filaments without corresponding filament sleeves, e.g., reinforcement filament 336-1.

Turning now to FIG. 3D, a fourth reinforcement filament and thermoplastic filament distribution 340 is configured to illustrate a filament subassembly configuration. The fourth distribution 340 includes a plurality of filament subassemblies 343-1, . . . , 343-m contained in a sleeve 346. Each filament subassembly, e.g., filament subassembly 343-1, includes a plurality of reinforcement filaments 342-1, 342-2, and a plurality of thermoplastic filaments 344-1, 344-2, contained in a respective tubular thermoplastic filament, e.g., tubular thermoplastic filament 345-1. The sleeve 346 is configured to contain the plurality of filament subassemblies 343-1, . . . , 343-m. In one nonlimiting example, the sleeve 346 may be formed of a thermoplastic material similar to or the same as the thermoplastic filaments 344-1, 344-2. In another example, the sleeve 346 may be formed of a thermoplastic material different from the thermoplastic material(s) used for the thermoplastic filaments.

Turning now to FIG. 3E, a fifth reinforcement filament and thermoplastic filament distribution 350 is configured to illustrate a uniform distribution with unequal numbers of thermoplastic filaments and reinforcement filaments. The fifth flexible rebar preform distribution 350 includes a plurality of reinforcement filaments 352-1, 352-2, . . . , 352-m, and a plurality of tubular thermoplastic filaments 354-1, 354-2, . . . , 354-n. In this fifth distribution 350, a number, m, reinforcement filaments is not equal to a number, n, thermoplastic filaments. Additionally or alternatively, in this fifth distribution 350, the reinforcement filaments 352-1, 352-2, . . . , 352-m are generally centered in the distribution 350 and the thermoplastic filaments 354-1, 354-2, . . . , 354-n generally encircle the reinforcement filaments 352-1, 352-2, . . . , 352-m in the distribution cross-section 350.

Turning now to FIG. 3F, a sixth reinforcement filament and thermoplastic filament distribution 360 is configured to illustrate a combination distribution with a combination of nonuniformly distributed reinforcement filament and tubular thermoplastic filament pairs, nonuniformly distributed reinforcement filaments, and nonuniformly distributed thermoplastic filaments. In some embodiments, one or more of the filament and/or filament pair distributions may be random. In some embodiments, one or more of the filament and/or filament pair distributions may be uniform.

The sixth flexible rebar preform distribution 360 includes a plurality of reinforcement filament and tubular thermoplastic filament pairs 363-1, . . . , 363-m, a plurality of reinforcement filaments 366-1, 366-2, . . . , 366-n, and a plurality of thermoplastic filaments 368-1, . . . , 368-p. In this sixth distribution 360, a number, n, reinforcement filaments is not equal to a number, p, thermoplastic filaments. Each reinforcement filament and tubular thermoplastic filament pair, e.g., reinforcement filament and tubular thermoplastic filament pair 363-1, includes a reinforcement filament 362-1 and tubular thermoplastic filament 364-1.

Thus, a flexible rebar preform, according to the present disclosure, may include at least one reinforcement filament and at least one thermoplastic filament. The filaments may be arranged in a variety of configurations with corresponding cross-section distributions, and may include a preform sleeve and/or one or more thermoplastic filament sleeves.

Turning again to FIG. 1, system 100 is configured to receive the flexible rebar preform (“preform”) 102 as input, and to produce rebar 104 as output. The flexible rebar preform 102 may generally be manufactured as a continuous rope with a length greater than a respective length of each rebar ultimately formed from the preform. In an embodiment, the continuous rope may be coiled, e.g., coil 108, for ease of transport. For example, the preform 102 may be received coiled around a spool. In another example, the preform 102 may be received coiled around a reel or a spool. As used herein, “spool” and “reel” may be used interchangeably and mean a generally cylindrical device that the flexible rebar preform may be coiled around. In another example, the preform 102 may be received coiled in a cassette. The coil 108 of flexible continuous rope may thus correspond to a roll of composite feedstock. It may be appreciated that the flexible attribute of the continuous rope facilitates coiling and ease of transport to, for example, a construction site.

System 100 includes a pultrusion die 112, a pulling apparatus 114, a cutting apparatus 116, and a bending apparatus 118. In some embodiments, system 100 may include a sealing apparatus 120. In some embodiments, system 100 may include a preheater 110. The processing stages 110, 112, 114, 116, 118, and 120 are generally drawn as a sequence, for ease of illustration. In some embodiments, a plurality of processing operations may be performed by a same processing stage. In some embodiments, each processing operation may be performed by a respective processing stage.

In some embodiments, the flexible rebar preform 102 may be preheated prior to being provided to the pultrusion die 112. The preheating may be configured to raise the flexible rebar preform to a preheat temperature that is less than a melt temperature of the thermoplastic filament(s) included in the preform 102. The preheat temperature may be a few degrees (e.g., degrees Celsius (° C.)) less than the melt processing temperature of the thermoplastic material. The preheat temperature may be on the orders of 1° C. or 10° C. less than the melt processing temperature of the thermoplastic material. In one nonlimiting example, the preheat temperature may be 10° C. less than the melt processing temperature of the thermoplastic material. However, this disclosure is not limited in this regard.

In an embodiment, the coil 108 of preform may be contained in a cassette 106, e.g., a temperature controlled cassette. The cassette 106 may be configured to contain at least one heating element, e.g., heating elements 122-1, 122-2. The heating elements 122-1, 122-2 may be configured to heat the coil 108 to the preheat temperature and the cassette may be configured to facilitate achieving and maintaining the temperature of the coil 108 and thus the preform 102 to the preheat temperature.

In another embodiment, system 100 may include preheater 110. The preheater 110 may be configured to preheat at least a portion of the flexible rebar preform to the preheat temperature. The preheater 110 may be positioned between the source of the preform, e.g., coil 108 and/or cassette 106. The preheater 110 is configured to receive the preform 102 and to heat the preform 102 to the preheat temperature. In one nonlimiting example, the preheater 110 may correspond to an electric heating unit. In another example, the preheater 110 may be powered by a renewable energy source, e.g., photovoltaics. However, this disclosure is not limited in this regard. The preheater 110 may include, but is not limited to, an infrared heat source, a microwave heat source, dielectric heat source that includes a high-frequency electromagnetic field. It may be appreciated that dielectric heating provides a uniform cross-sectional heating of materials that are poor electrical conductors, including, for example, thermoplastic materials and/or natural reinforcement materials, as described herein.

The flexible rebar preform 102, with or without preheating, may then be provided to the pultrusion die 112. The pultrusion die 112 is configured to form, i.e., consolidate, the flexible rebar preform 102 into a continuous consolidated rebar. As used herein, continuous consolidated rebar corresponds to consolidated preform. The pultrusion die 112 may thus be configured to provide and/or utilize pressure, heat, and/or shaping to form the continuous consolidated rebar. In some embodiments, the pultrusion die 112 may include or may be coupled to a heating apparatus configured to heat the preform to a heated temperature greater than or equal to a melt temperature of the thermoplastic material. The pultrusion die 112 may include a consolidation die portion 124 and one or more electric heating elements, e.g., heating elements 126-1, 126-2, 126-3. For example, the electric heating elements may correspond to electric heating bands. In another example, the electric heating elements may correspond to embedded electric cartridge heaters. However, this disclosure is not limited in this regard. The pultrusion die 112 may be configured to maintain a relatively constant inner wall temperature and is configured to have an appropriate geometrical shape, e.g., rectangular, circular, ellipsoidal, etc. In some embodiments, the pultrusion die 112 may include an insulation portion 113, e.g., an insulation jacket. The insulation portion 113 is configured to reduce or eliminate heat loss from the pultrusion die 112 and may thus enhance energy efficiency. It may be appreciated that a pull rate through the pultrusion die is related to providing sufficient time for complete matrix (i.e., thermoplastic filament) melting, composite impregnation and consolidation, and the appropriate cross-sectional shape (e.g., round, rectangular).

In some embodiments, the pultrusion die 112 may include a passive cooling apparatus 128, e.g., a heat sink, following the heating element(s), configured to partially or completely cool the continuous consolidated rebar. The cooling may be configured to facilitate maintaining a shape, e.g., specific cross section geometry, of the consolidated preform. In other words, the cooled consolidated rebar may be less malleable or no longer malleable.

As is known, pultrusion generally operates by pulling feedstock through a corresponding die. System 100 may thus include a pulling apparatus 114, following the pultrusion die 112. The pulling apparatus 114 is configured to pull the preform 102 from the composite feedstock 108 through the preheater 110 (if present) and through the pultrusion die 112. It may be appreciated that the preform exiting the pultrusion die may remain malleable thus facilitating texturing an exterior surface of the composite and later bending. It may be appreciated that texturing an exterior surface of the rebar is configured to provide a better mechanical adhesion to a cementitious material.

The pulling apparatus 114 may include one or more rollers, e.g., rollers 130-1, 130-2, and a drive mechanism 132. In some embodiments, the pulling apparatus 114 may include rollers having a surface configured to provide a textured surface on the preform. For example, the roller surfaces may include one or more ridges, geometric structures, etc. In one nonlimiting example, the textured surface may facilitate fixing and holding the resulting rebar within the cementitious material. In some embodiments, the pulling apparatus 114 may be configured to control a speed of the rollers. The speed of the rollers may be related to a target upstream pull force and/or a frictional force possible at the rebar/drive roll interface.

In some embodiments, system 100 may include a cooling apparatus 133 positioned at or near the pulling apparatus 114. In one nonlimiting example, the cooling apparatus 133 may include one or more cooling fan(s) 134-1, 134-2. However, this disclosure is not limited in this regard. In another nonlimiting example, the cooling may correspond to active convective cooling. An amount of cooling may be related to a target malleability associated with bending. The cooling apparatus 133 may be configured to cool at least a surface of the consolidated rebar to, for example, facilitate maintaining a selected cross section geometry.

The pulling apparatus 114 may then provide the consolidated (and cooled) rebar to a cutting apparatus 116. The cutting apparatus 116 is configured to cut the continuous consolidated (i.e., partially processed) preform to a specified length. The cutting apparatus 116 may include a cutting portion 136-1 and a support portion 136-2, configured to push against the cutting portion 136-1 to provide stability during a cutting operation. The cutting apparatus 116 may include, but is not limited to, a shearing device, a hot knife, a compression cutter, etc. The cut consolidated rebar may then be provided to a bending apparatus 118.

The bending apparatus 118 is configured to bend the consolidated rebar that has been cut into a prespecified shape. In one nonlimiting example, the bending apparatus may correspond to a CNC (computer numerical control) machine. However, this disclosure is not limited in this regard. The bends may be relatively simple or relatively complex, e.g., compound bends in a plurality of angles and/or orientations. In some embodiments, the bending apparatus 118 may include or may be coupled to a heating apparatus configured to reheat the cut consolidated rebar to facilitate the bending process.

In some embodiments, system 100 may include a sealing apparatus 120. The sealing apparatus 120 is configured to provide a seal on a cut end of the rebar. In one nonlimiting example, the seal may include a thermoplastic material related to a thermoplastic filament material included in the preform. In another example, the seal may correspond to an end cap. It may be appreciated that sealing the cut ends of the rebar may facilitate resistance to deterioration.

Thus, a flexible rebar preform that includes at least one reinforcement filament and at least one thermoplastic filament may be processed into rebar having a selected shape, and surface texture. The processing may be performed by a pultruding machine at a job-site.

FIG. 4 is a sketch 400 illustrating one example roller and bending configuration, according to one embodiment of the present disclosure. Example 400 is one example of bending apparatus 118 of FIG. 1. Example roller and bending configuration 400 is configured to receive a consolidated rebar 402 as input and to provide a bent and possibly textured rebar 404 as output. Example roller and bending configuration 400 includes a rotating assembly 408 configured to rotate about a first axis 406-1 and/or a second axis 406-2 to provide a selected bend angle and/or orientation. Example roller and bending configuration 400 includes a plurality of wheels 410-1, . . . , 410-4 configured to hold the consolidated rebar and to texture a surface of the rebar 404.

FIG. 5 is a sketch 500 illustrating one example bending mechanism, according to one embodiment of the present disclosure. Example 500 is one example of bending apparatus 118 of FIG. 1. Example roller and bending configuration 500 is configured to receive a consolidated rebar 502 as input and to provide a bent and possibly textured rebar 504 as output. Example roller and bending configuration 500 includes a rotating assembly 508 configured to rotate about a first axis and/or a second axis to provide a selected bend angle and/or orientation and/or to texture a surface of the rebar 504.

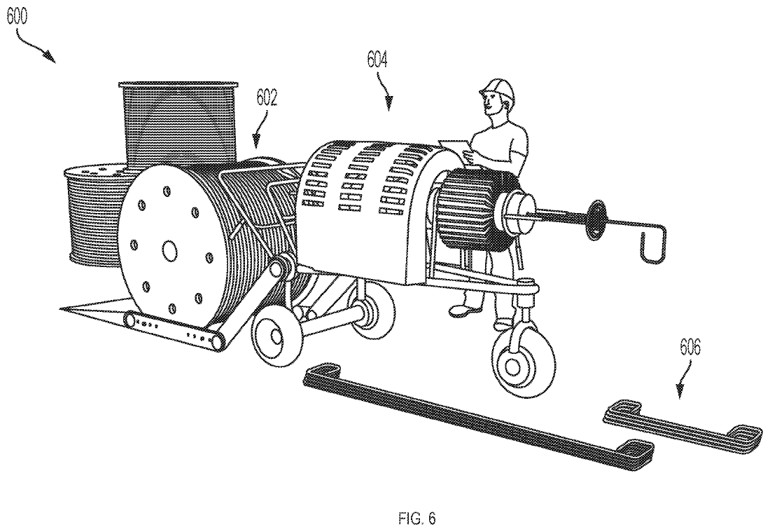

FIG. 6 is a sketch illustrating one example system 600 for producing rebar, according to one embodiment of the present disclosure. Sketch 600 includes rolls of feedstock, e.g., flexible rebar preform 602, as described herein, and a portable system 604 for producing rebar, e.g., rebar 606, at a job site, as described herein.

Generally, this disclosure relates to formation of thermoplastic composite rebar that can be formed in a factory setting or can be formed on-site. The thermoplastic composite rebar, according to the present disclosure, may be formed from a flexible rebar preform that includes at least one reinforcement filament and at least one thermoplastic filament. The thermoplastic filament is configured to form a thermoplastic matrix in the thermoplastic composite rebar. The thermoplastic composite rebar is configured to be non-corrosive thus significantly lengthening the service life of reinforced concrete. Natural fibers have higher tensile strength and similar specific tensile modulus compared to steel reinforcing, and when combined with a thermoplastic matrix, are configured to have a lower embodied energy and carbon footprint than steel over a service life of the rebar.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

1. A flexible rebar preform comprising:
at least one reinforcement filament, and
at least one thermoplastic filament,
the at least one reinforcement filament and the at least one thermoplastic filament arranged in a selected distribution across a cross-section of the preform.

2. The flexible rebar preform of claim 1, comprising a plurality of thermoplastic filaments, a concentration of the plurality of thermoplastic filaments across the cross-section of the preform having a gradient configured to provide at least one of a selected mechanical property and/or a selected processing characteristic.

3. The flexible rebar preform of claim 1, wherein a ratio of reinforcement filament volume to preform volume is related to one or more of an interfacial shear strength between a reinforcement filament material and a thermoplastic filament material, an associated rebar tensile modulus, an associated rebar tensile strength, an associated rebar bending modulus, and/or an associated rebar bending strength.

4. The flexible rebar preform according to claim 1, wherein the flexible rebar preform comprises at least one of a sleeve or a braid configured to contain the at least one reinforcement filament and the at least one thermoplastic filament.

5. The flexible rebar preform according to claim 1, wherein each reinforcement filament comprises a natural fiber.

6. The flexible rebar preform according to claim 1, wherein each reinforcement filament comprises a material selected from the group comprising hemp, flax, glass, jute, kenaf, ramie, sisal, basalt, carbon, aramid, and/or a combination thereof.

7. The flexible rebar preform according to claim 1, wherein each thermoplastic filament comprises a material selected from the group comprising PET (poly(ethylene terephthalate)), polyamide polymer, HDPE (high-density polyethylene), polyethylene, PMMA (poly methyl methacrylate), polyester, PLA (polylactic acid), POM (poly oxy methylene), polypropylene, polyurethane, PVDF (polyvinylidene fluoride) and/or a combination thereof.

8. A method of producing rebar, the method comprising:
receiving, by a pultruding machine, a flexible rebar preform comprising at least one reinforcement filament, and at least one thermoplastic filament, the at least one reinforcement filament, and the at least one thermoplastic filament arranged in a selected distribution across a cross-section of the preform;
heating, by the pultruding machine, the flexible rebar preform to a first temperature, the first temperature greater than or equal to a melt temperature of the thermoplastic filament;
pulling, by a pulling apparatus, the flexible rebar preform through a pultrusion die to form the rebar;
cutting, by a rebar cutting apparatus, the rebar at a prespecified length; and
bending, by a bending apparatus, the cut rebar to a prespecified bend geometry.

9. The method of claim 8, wherein the flexible rebar preform is received coiled around a spool, or coiled in a cassette.

10. The method of claim 8, further comprising preheating, by a preheating apparatus, the flexible rebar preform to a second temperature, the second temperature less than a melt temperature of the thermoplastic filament.

11. The method of claim 8, wherein the heating to the first temperature occurs in the pultrusion die.

12. The method of claim 8, wherein the pulling apparatus comprises a plurality of drive rollers, and further comprising texturing, by the plurality of drive rollers, an outer surface of the rebar.

13. The method of claim 8, wherein the pultruding machine is configured to be portable and to produce the rebar on a job site.

14. The method of claim 8, wherein the flexible rebar preform comprises a plurality of thermoplastic filaments, a concentration of the plurality of thermoplastic filaments across the cross-section of the preform having a gradient configured to provide at least one of a selected mechanical property and/or a selected processing characteristic.

15. The method of claim 8 wherein a ratio of reinforcement filament volume to preform volume is related to one or more of an interfacial shear strength between a reinforcement filament material and a thermoplastic filament material, an associated rebar tensile modulus, an associated rebar tensile strength, an associated rebar bending modulus and/or an associated rebar bending strength.

16. The method of claim 8, wherein the flexible rebar preform comprises at least one of a sleeve or a braid configured to contain the at least one reinforcement filament and the at least one thermoplastic filament.

17. A system for producing rebar, the system comprising:
a pultruding machine configured to receive a flexible rebar preform comprising at least one reinforcement filament, and at least one thermoplastic filament, the at least one reinforcement filament, and the at least one thermoplastic filament arranged in a selected distribution across a cross-section of the preform,
the pultruding machine comprises a pulling apparatus, a rebar cutting apparatus, and a bending apparatus, and is configured to heat the flexible rebar preform to a first temperature, the first temperature greater than or equal to a melt temperature of the thermoplastic filaments;
the pulling apparatus is configured to pull the flexible rebar preform through a pultrusion die to form the rebar, the rebar cutting apparatus is configured to cut the rebar at a prespecified length, and the bending apparatus is configured to bend the cut rebar to a prespecified bend geometry.

18. The system of claim 17, wherein each reinforcement filament comprises a material selected from the group comprising hemp, flax, glass, jute, kenaf, ramie, sisal, basalt, carbon, aramid and/or a combination thereof.

19. The system of claim 17, wherein each thermoplastic filament comprises a material selected from the group comprising PET (poly(ethylene terephthalate)), polyamide polymer, HDPE (high-density polyethylene), polyethylene, PMMA (poly methyl methacrylate), polyester, PLA (polylactic acid), POM (poly oxy methylene), polypropylene, polyurethane, PVDF (polyvinylidene fluoride) and/or a combination thereof.

20. The system according to claim 17, further comprising a preheating apparatus configured to preheat the flexible rebar preform to a second temperature, the second temperature less than a melt temperature of the thermoplastic filament.
